(19) United States
(12) Patent Application Publication
(10) Pub. No.: US 2005/0195857 A1
(43) Pub. Date: Sep. 8, 2005

(54) METHOD AND APPARATUS FOR EXTRACTING PAYLOAD FROM A PACKETIZED ELEMENTARY STREAM PACKET

(76) Inventor: Ching-Yu Tsai, Taipei Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/906,701

(22) Filed: Mar. 2, 2005

(30) Foreign Application Priority Data
Mar. 3, 2004 (TW) 093105630

(51) Int. Cl. H04L 12/28

(52) U.S. Cl. 370/470

(57) ABSTRACT

A data extracting system for extracting a payload from a PES packet of a transport stream or a program stream includes a data source for providing a PES packet; a packet-processing device electrically connected to the data source for calculating length of the PES packet and generating a corresponding packet length value; a transmitting interface electrically connected to the packet-processing device for outputting the payload of the PES packet stored in the packet-processing device; and a control circuit for controlling operation of the data extracting system; wherein the control circuit controls the transmitting interface to output the payload of the PES packet according to the packet length value.

### BACKGROUND

The invention relates to a method of extracting the payload from a data packet and a related apparatus, and more particularly, to a method of extracting the payload from a packetized elementary stream packet and a related apparatus.

Encoded video data is referred to as an elementary stream (ES). An ES becomes a packetized elementary stream (PES) through a packetize processing. According to the standard of moving picture coding experts group 2 (MPEG2), two streams that are defined for transmitting a PES are program stream (PS) and transport stream (TS).

PS is preferred to be used in a storage medium where errors rarely occur. The reason that PS is not used in a system which needs to check errors is that the size of the PS packet is not fixed. Compressed data of a PS is usually stored on discs such as DVD discs. A PS is basically similar to the system stream of MPEG1, but provides some advanced functions by utilizing advanced syntax and new equations.

TS utilizes fixed-size packets. This makes it not only easy for hardware to process the data but also easy to execute error corrections. Therefore, TS is mainly utilized for transmission when errors easily occur such as IEEE 1394 protocol or digital video broadcasting (DVB). Each TS packet occupies 188 bytes, wherein the first 4 bytes are a header and the payload after the header is data of a PES packet. Each header of the TS packet has a field for storing a packet identifier (PID), which represents whether the contents of the TS packet correspond to video data, audio data, or other data.

Generally speaking, when the related art transmits a payload of a PES packet through direct memory access (DMA), the required parameters includes a source address, a destination address, a transmitting length, etc. This all depends on the PES packet length information stored in the PES packet header. However, each PES packet header only has a 2-byte (16 bit) field for storing the packet length. Therefore, the field is defined as 0 if the packet length of the PES packet is larger than what a 16-bit field can represent (refer to ISO/IEC 13818-1, Information Technology-Generic Coding of Moving Pictures and Associated Audio Information: Systems). Therefore, if the packet length field is defined as 0, the related art is not capable of transmitting data through DMA because it is unable to determine the PEC packet length from the PEC packet header. This makes data transmission inefficient.

### SUMMARY

It is therefore an objective of the claimed invention to provide a method and a related device for extracting a payload from a PES packet by calculating an actual packet length of the PES packet to solve the above-mentioned problem.

According to an embodiment of the present invention, a method of extracting a payload of a packetized elementary stream packet (PES packet) from a packetized elemebtary stream (PES) includes utilizing a packet processing device for calculating a length of the PES packet to generate a corresponding packet length value; and outputting the payload of the PES packet according to the packet length value.

According to another embodiment of the present invention, a data-extracting system for extracting a payload of a packetized elementary stream packet (PES packet) from a transport stream (TS) or a program stream (PS) includes a data source device for providing a PES packet; a packet processing device electrically connected to the data source device for calculating packet length of the PES packet to generate a packet length value; a transmitting interface electrically connected to the packet processing device for receiving the PES packet from the packet processing device and outputting the payload of the PES packet; and a controller for controlling the operation of the data-extracting system; wherein the controller controls the transmitting interface to output the payload of the PES packet according to the packet length value.

An advantage of the present invention is that the payload of PES packets is capable of being transmitted through DMA by calculating the PES packet length when receiving the PES packet even if the packet length field is defined as 0 or the packet length stored in the packet length field is incorrect so that the above-mentioned inefficiency of data transmission is eliminated.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of a data-extracting system according to the present invention.

FIG. 2 is a flowchart of a method of extracting a payload from a PES packet according to the present invention

FIG. 3 is a timeline diagram of an embodiment of the calculating device of FIG. 1.

FIGS. 4 and 5 are other embodiments of the calculating device of FIG. 1.

### DETAILED DESCRIPTION

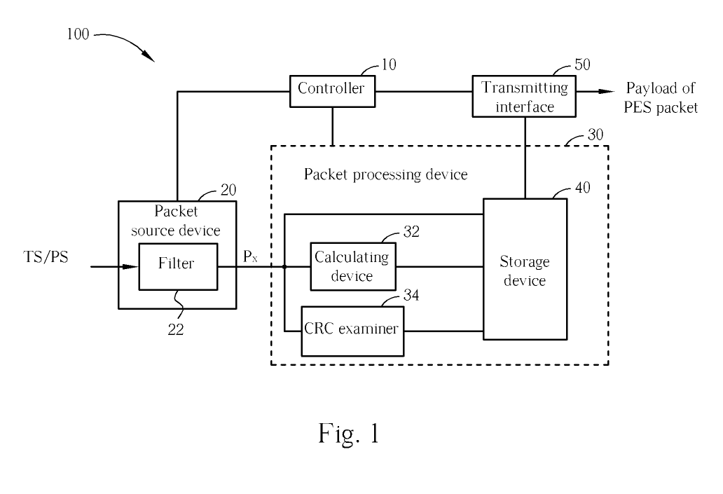

Please refer to FIG. 1, which is a schematic diagram of a data-extracting system 100 according to the present invention. The data-extracting system 100 comprises a controller 10, a packet source 20 electrically connected to the controller 10, a packet processing device 30 electrically connected to the controller 10 and the packet source 20, and a transmitting interface 50 electrically connected to the controller 10 and the packet processing device 30. The controller 10 is utilized for controlling the operation of the data-extracting system 100. The packet source device 20 is utilized for receiving and filtering a TS or a PS to output a PES packet (Px). The packet processing device 30 is mainly utilized for receiving the PES packet (Px) and calculating the packet length of the PES packet (Px). The packet processing device 30 comprises a calculating device 32, a cyclic redundancy check (CRC) examiner 34, and a storage device 40. The transmitting interface 50 is utilized for outputting payload (Payload_x) of the PES packet (Px).

The data-extracting system 100 utilizes the packet source device 20 to receive a PS or a TS and extracts a PES packet (Px) from the PS or TS. The data-extracting system 100 then utilizes the packet processing device 30 to calculate the packet length of the PES packet (Px), and finally utilizes the controller 10 to control the transmitting interface 50 according to the packet length for outputting the payload of the PES packet (Px) through DMA. The details of the data-extracting system 100 are illustrated in the following.

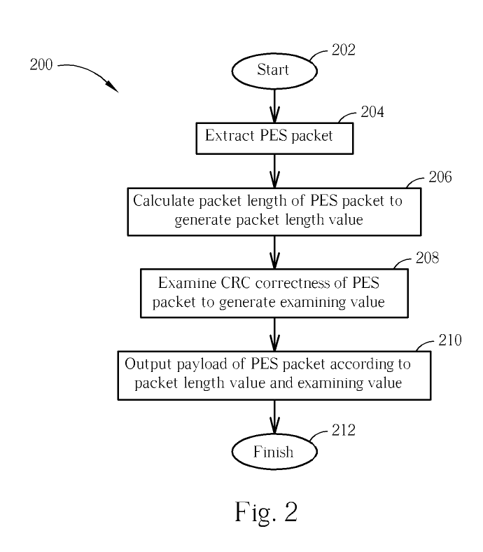

Please refer to FIG. 2 in conjunction with FIG. 1. FIG. 2 is a flowchart 200 of the data-extracting system 100 to extract payload of a PES packet from a PS or a TS. The flowchart 200 comprises following steps:

Step 202: Start.

Step 204: Utilize the packet source device 20 to receive and filter a TS or a PS for providing a PES packet (Px).

Step 206: Utilize the calculating device 32 of the packet processing device 30 to calculate the packet length of the PES packet (Px) for generating a corresponding packet length value (Length_x).

Step 208: Utilize the cyclic redundancy check (CRC) examiner 34 of the packet processing device 30 to examine the correctness of the CRC of the PES packet (Px) for generating a corresponding examining value (CRC_x).

Step 210: Utilize the controller 10 to control the transmitting interface 50 to output payload (Payload_x) of the PES packet (Px) according to the packet length value (Length_x) and the examining value (CRC_x).

Step 212: Finish.

Take for example the situation where the data-extracting system 100 extracts payload of a PES packet from a TS to help illustrate the operation of the flowchart 200.

In step 204, the data-extracting system 100 of the present invention utilizes the packet source 20 to receive a TS and utilizes a filter 22 of the packet source device 20 to filter the received TS. In this preferred embodiment, the stream transmitted into the packet source device is a TS, therefore, the filter 22 can be a packet identifier filter (PID filter) for filtering the needed TS packets from the received TS and recombining the needed TS packets to output a PES packet (Px). The PES packet (Px) is transmitted into the packet processing device 30 to be processed and temporarily stored in the storage device 40.

In step 206, the packet processing device 30 utilizes the calculating device to calculate the bit-number of the PES packet (Px) when receiving the PES packet (Px). Therefore, the calculating device 32 is capable of calculating the packet length of the PES packet, generating a packet length value (Length_x) while receiving the PES packet (Px), and storing the packet length value (Length_x) in the storage device 40.

Please note that a technical characteristic of the present invention lies in that while the packet source device 20 filters out the PES packet (Px) from a PS or a TS and transmits the PES packet (Px) into the packet processing device 30, the packet processing device 30 immediately utilizes the calculating device 32 to calculate the packet length of the PES packet (Px). In the preferred embodiment, the calculating device 32 executes the calculating operation according to related signals generated while the filter 22 filters out the PES packet (Px). The details of operation will be illustrated later.

In step 208, the packet processing device 30 utilizes the cyclic redundancy check (CRC) examiner 34 to examine the correctness of the CRC stored in the header of the PES packet (Px) for generating a corresponding examining value (CRC_x) and storing the examining value (CRC_x) in the storage device 40. In the preferred embodiment, if the result of examining the CRC of the PES packet (Px) is correct, the CRC examiner 34 set the examining value (CRC_x) as 1. On the contrary, if the result of examining the CRC of the PES packet (Px) is incorrect, the CRC examiner 34 sets the examining value (CRC_x) as 0. Values of the above-mentioned examining value (CRC_x) are used only for illustration and are not meant as limitations. For example, values of the above-mentioned examining value (CRC_x) are able to be some other predetermined values instead of 0 and 1.

Additionally, in the flowchart 200, the ordering of step 206 and step 208 is for illustration only and not meant as a limitation. In fact, the order of steps 206 and 208 can be reversed while maintaining the concept of the present invention.

In step 210, the controller 10 of the data-extracting system 100 reads the packet length value (Length_x), the examining value (CRC_x), and the header of the PES packet (Px) stored in the storage device 40 to control the transmitting interface 50 to output the payload (Payload_x) of the PES packet (Px).

If the examining value (CRC_x) read by the controller 10 is 0, this represents that an error may occur when transmitting the PES packet (Px). Therefore, the controller 10 controls the transmitting interface 50 to abort transmitting the payload (Payload_x) of the PES packet (Px). On the contrary, if the examining value (CRC_x) is 1, this represents that contents of the PES packet (Px) are correct. Therefore, the controller 10 is capable of calculating the length of payload (Payload_x) of the PES packet Px according to the read packet length value (Length_x). Because the packet length value (Length_x) represents the sum of the header and payload (Payload_x) of the PES packet (Px) and the header length of the PES packet (Px) is stored in the PES header length field, the controller 10 is capable of calculating the actual length value (Length_x_payload) of payload (Payload_x) of the PES packet (Px) by utilizing the packet length value (Length_x) to subtract the header length of the PES packet (Px) after reading the header of the PES packet from the storage device 40 to know the header length of the PES packet.

Therefore, the controller 10 is capable of getting the starting address (Address_x_payload) of the payload (Payload_x) of the PES packet (Px) by simply shifting the header length value of the PES packet (Px) from the address of the PES packet (Px) in the storage device 40. In step 210, the controller 10 is capable of transmitting the starting address (Address_x_payload) and the length (Length_x_payload) into the transmitting interface 50 to allow the transmitting interface 50 to transmit the payload (Payload_x) of the PES packet (Px) into a target device (such as a memory or a video decoder) through DMA according to the starting address (Address_x_payload) and the length (Length_x_payload).

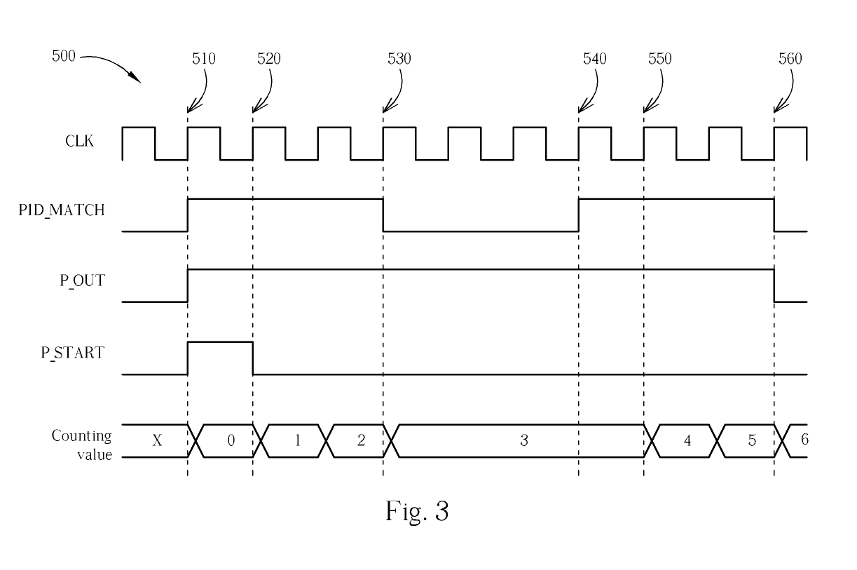

FIG. 3 is utilized for illustrating the above-mentioned method of calculating the PES packet (Px). Please refer to FIG. 3, which is a timeline diagram 500 of an embodiment of the calculating device 32 in FIG. 1. The clock signal CLK is a working clock of the calculating device 32. The signal PID_MATCH indicates whether a TS packet being processed is one of the packets used to recombine the PES packet. If the signal PID_MATCH is 1, this indicates that a TS being processed by the filter 22 is one of the packets used to be recombined into the PES packet (Px). Therefore, the calculating device 32 counts the byte data received by the packet processing device 30. On the contrary, if the signal PID_MATCH is 0, the calculating device 32 does not count the byte data received by the packet processing device 30. The signal P_OUT indicates the state of the filter 22 outputting packets. If the signal P_OUT is 1, this indicates that the filter 22 is transmitting data into the packet processing device 30. Therefore, the signal P_OUT can be regarded as an enabling signal of the calculating device 32. The signal P_START indicates whether the byte data outputted by the filter 22 is a starting point of the PES packet (Px). If the signal P_START is 1, this indicates that the byte data being outputted by the filter 22 is a starting point of the PES packet (Px). Therefore, in this embodiment, the calculating device 32 resets to 0 at the rising edge of P_START and begins counting when triggered at the rising edge of the next working clock CLK.

As shown in FIG. 3, at time 510, the signal P_OUT is 1, and this indicates that the filter 22 transmits data into the packet processing device 32. At this time, the signal PID_MATCH is 1, and the signal P_START is also 1. This indicates that the data received by the packet processing device is a starting point of the PES packet (Px), so the calculating device 32 has to reset to 0 and start to count when the rising edge of the next working clock CLK occurs. The counting value of the calculating device 32 starts to increase from a value of 1 at time 520 to a value of 3 at time 530. However, between time 530 and time 54, the calculating device 32 stops counting because the signal PID_MATCH is 0 so that the counting value remains 3.

Next, at time 540, because the signal PID_MATCH becomes 1 again, the calculating device 32 continues to increase the counting value when the rising edge of the next working clock CLK occurs (at time 550). This occurs until time 560, where the signal P_OUT becomes 0 to indicate that the filter 22 stops transmitting data into the packet processing device 32. Therefore, the calculating device pauses the counting value and, at this time, the counting value is 6. Before the signal P_START becomes 1 again, the counting value is incremented to indicate that the data being outputted by the filter 22 still belongs to the PES packet (Px). This also means that in the preferred embodiment, when the packet source device 20 completely transmits the PES packet (Px) into the packet processing device, the calculating device 32 is capable of completely calculating the packet length of the PES packet (Px) and generating the corresponding length value (Length_x). Therefore, the present invention calculating device 32 does not delay the time of transmitting the PES packet (Px) when calculating the packet length of the PES packet.

Please note that the PES packet (Px), the packet length value (Length_x), and the examining value (CRC_x) are all stored in the storage device 40. In an embodiment of the present invention, the storage device 40 is a volatile memory (such as DRAM or SRAM). The PES packet (Px) and other related information (such as the packet length value Length_x and the examining value CRC_x) are capable of being transmitted into the storage device 40. Therefore, the PES packet (Px), the packet length value (Length_x), and the examining value (CRC_x) can be orderly outputted in order to be stored in the continuous addresses of the storage device 40 or respectively stored in different positions of the storage device 40.

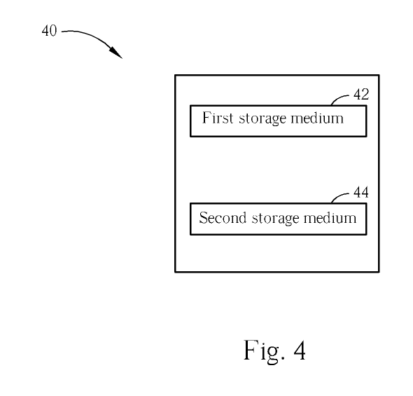

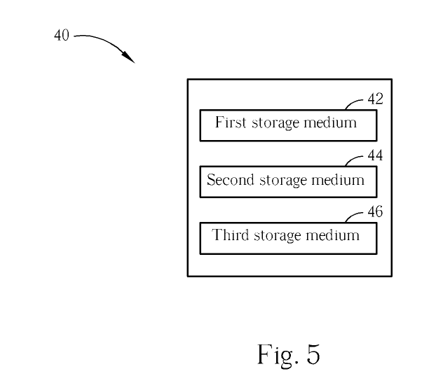

However, in practice, the storage device 40 is capable of being composed of different storage mediums. Please refer to FIGS. 4 and 5. FIGS. 4 and 5 are different embodiments of the calculating device in FIG. 1. As shown in FIG. 4, the storage device 40 comprises a first storage medium 42 electrically connected to the packet source device 20, and a second storage medium 44 electrically connected to the calculating device 32 and the CRC examiner 34. The first storage medium 42 can be a volatile memory (such as DRAM or SRAM) for temporarily storing the PES packet (Px). The second medium 44 can be a volatile memory or a buffer for temporarily storing the packet length value (Length_x) and the examining value (CRC_x). The storage device 40 in FIG. 5 comprises a first storage medium 42 electrically connected to the packet source device 20, a second storage medium 44 electrically connected to the calculating device 32, and a third storage medium 46 electrically connected to the CRC examiner 34. As mentioned above, the first storage medium 42 can be a volatile memory (such as DRAM or SRAM) for temporarily storing the PES packet (Px). The second storage medium 44 can be a volatile memory or a buffer for temporarily storing the packet length value (Length_x). The third storage medium 46 can also be a volatile memory or a buffer for temporarily storing the examining value (CRC_x). A storage medium for temporarily storing the PES packet (Px), the packet length value (Length_x), and the examining value (CRC_x) can be regarded as an implementation according to the present invention.

Furthermore, in the above-mentioned illustration of the flowchart 200 in FIG. 2, assuming that the data-extracting system 100 extracts a payload of a PES packet from a TS. As mentioned above, the data-extracting system 100 of the present invention is capable of extracting payload of a PES packet from a PS. The operation is simply illustrated in the following.

In step 204, when the packet source device 20 receives a PS, the filter 22 is used for filtering the PS. In this embodiment, the filter 22 is a PS to PES filter for filtering out the needed PS packets from the PS and recombining the PS packet into a PES packet (Py). And then, the PES packet (Py) is transmitted into the packet processing device 30 to be processed and stored in the storage device 40.

In step 206, the packet processing device 30 utilizes the calculating device 30 to calculate the packet length value (Length_y) of the PES packet (Py) when receiving the PES packet (Py). Then, in step 208, the packet processing device 30 utilizes the CRC examiner 34 to examine the correctness of the CRC stored in the header of the PES packet (Py) for generating a corresponding examining value (CRC_y) and storing the examining value (CRC_y) in the storage device 40.

Similarly, in step 210, the controller 10 of the data-extracting system 100 reads the packet length value (Length_y), the examining value (CRC_y), and the header of the PES packet (Py) stored in the storage device 40 for controlling the transmitting interface 50 to output payload (Payload_y) the PES packet (Py) into a target device through DMA.

As mentioned above, the data-extracting system 100 processes a PS or a TS similarly. The only difference between them is the function of the filter 22. In fact, the packet source device 20 is capable of comprising a PID filter and a PS to PES filter. When the packet source device 20 receives a stream, the packet source device 20 has to determine whether the stream is a PS or a TS, and then selects the corresponding filter to process the received stream for providing a PES packet. And then step 206˜step 210 in flowchart 200 are executed so that the data-extracting system 100 outputs the payload of the PES packet through DMA.

Please note that in the preferred embodiment according to the present invention, the packet processing device 30 utilizes the CRC examiner 34 to examine the correctness of the CRC and generate a corresponding examining value for the controller 10 to control the operation of transmitting interface 50 in step 208. The CRC examiner 34 is used for examining and reducing errors during packets transmission. However, the present invention packet processing device 30 is not limited to having the CRC examiner 34. This also means that the step 208 can be ignored. At this time, in step 210, the controller 10 controls the transmitting interface 50 to output payload (Payload_x) of the PES packet (Px) according to the packet length value (Length_x).

Additionally, the data-extracting system 100 is capable of being implemented using software program code. The devices of the data-extracting system 100 can be all implemented as program code. So, when a computer system executes the program code, the computer is capable of transmitting the payload of a PES packet from a PS or TS according to the present invention.

As mentioned above, no matter whether the packet length field of a PES packet header is defined as 0 or not, the present invention data-extracting system is capable of utilizing the calculating device 32 to calculate the actual packet length of the PES packet when filtering out the PES packet. Therefore, the present invention is capable of efficiently getting the information of packet length of the PES packet and transmitting payload normally, regardless of whether the packet length field of a PES packet header is defined as 0 or not.

In contrast to the related art, which cannot get the actual length of the PES when the packet length field of a PES packet header is defined as 0, the present invention can get the actual length of the PES packet so that the present invention has better transmitting efficiency and the data-extracting system and the method of extracting payload thereof are apparently improved.

Those skilled in the art will readily observe that numerous modifications and alterations of the device may be made while retaining the teachings of the invention. Accordingly, the above disclosure should be construed as limited only by the metes and bounds of the appended claims.

1. A method for extracting a payload of a packetized elementary stream packet (PES packet) from a packetized elementary stream (PES), the method comprising:
(a) utilizing a packet processing device to calculate a length of the PES packet to generate a corresponding packet length value; and
(b) outputting the payload of the PES packet according to the packet length value.

2. The method of claim 1, wherein step (b) further comprises:
utilizing a transmitting interface to output the payload of the PES packet.

3. The method of claim 2, further comprising:
utilizing a control circuit to control the transmitting interface to output the payload of the PES packet according the packet length value.

4. The method of claim 3, further comprising:
controlling the transmitting interface to output the payload of the PES packet according to an examining value corresponding to the correctness of a cyclic redundancy check (CRC) of the PES packet.

5. The method of claim 4, further comprising:
utilizing a cyclic redundancy check examiner to generate the examining value according to the correctness of the cyclic redundancy check.

6. The method of claim 4, further comprising:
utilizing a storage medium to store the PES packet, the packet length value, and the examining value.

7. The method of claim 4, further comprising:
utilizing a first storage medium to store the PES packet; and
utilizing a second storage medium to store the packet length value and the examining value.

8. The method of claim 4, further comprising:
utilizing a first storage medium to store the PES packet;
utilizing a second storage medium to store the packet length value; and
utilizing a third storage medium to store the examining value.

9. The method of claim 1 further comprising:
utilizing a storage medium to store the PES packet and the packet length value.

10. The method of claim 1 further comprising:
utilizing a first storage medium to store the PES packet; and
utilizing a second storage medium to store the packet length value.

11. A data-extracting system for extracting a payload of a packetized elementary stream packet (PES packet) from a transport stream (TS) or a program stream (PS) comprising:
a data source device for providing a PES packet;
a packet processing device electrically connected to the data source device for calculating a packet length of the PES packet to generate a packet length value;
a transmitting interface electrically connected to the packet processing device for receiving the PES packet from the packet processing device and outputting the payload of the PES packet; and
a controller for controlling the operation of the data-extracting system;
wherein the controller controls the transmitting interface to output the payload of the PES packet according to the packet length value.

12. The data-extracting system of claim 11, wherein the data source device comprises a packet identifier filter (PID filter) for filtering a transport stream to provide the PES packet.

13. The data-extracting system of claim 11, wherein the data source device comprises a PS-to-PES filter for filtering a program stream to provide the PES packet.

14. The data-extracting system of claim 11, wherein the packet processing device comprises:
a calculating device electrically connected to the data source device for calculating the packet length of the PES packet to generate the packet length value; and
a first storage medium electrically connected to the data source device and the transmitting interface for storing the PES packet and transmitting the PES packet to the transmitting interface;
wherein the first storage medium is used as a buffer between the data source device and the transmitting interface.

15. The data-extracting system of claim 14, wherein the packet length value is stored in the first storage medium.

16. The data-extracting system of claim 14, wherein the packet processing device further comprises a second storage medium electrically connected to the calculating device for storing the packet length value.

17. The data-extracting system of claim 14, wherein the packet processing device further comprises a cyclic redundancy check examiner electrically connected to the data source device for examining the correctness of the cyclic redundancy check to generate a examining value.

18. The data-extracting system of claim 17, wherein the controller controls the transmitting interface to output the payload of the PES packet according to the packet length value.

19. The data-extracting system of claim 17, wherein the examining value is stored in the first storage medium.

20. The data-extracting system of claim 17, wherein the packet processing device further comprises a second storage medium electrically connected to the calculating device for storing the examining value.

21. The data-extracting system of claim 17, wherein the packet processing device further comprises a third storage medium electrically connected to the cyclic redundancy check examiner for storing the examining value.
